(19) United States
(12) Patent Application Publication
(10) Pub. No.: US 2004/0246383 A1
(43) Pub. Date: Dec. 9, 2004

(54) Time sequenced user space segmentation for multiple program and 3D display

(76) Inventor: Ray M. Alden, Raleigh, NC (US)

Correspondence Address: Ray M. Alden, 808 Lake Brandon Trail, Raleigh, NC, 27610, US

(21) Appl. No.: 10/455,578

(22) Filed: Jun. 5, 2003

(51) Int. Cl. H04N 5/66

(52) U.S. Cl. 348/739; 348/771

(57) ABSTRACT

This invention provides a display means such as a television or computer monitor which uses time sequenced addressing to physically segment user space into segments which each receive different respective full resolution image streams (or television programs). The display uses a pixel generation mechanism such as a DMD to generate a rapid succession of pixels which are rapidly swept across the user space using a variable deflector operating in rapid iterations in cooperation with the DMD. First frame pixels from a first program are directed to a first user space segment, first frame pixels from a second program are directed to a second user space segment, and so on until all first frames are sent to applicable use space segments. Then the second frame is sent to each respective user space segment, and so on iteratively. A positionally segmented image display enables multiple users to each see full resolution programs on the same display at the same time. Alternately, a positionally segmented image display enables multiple users to each a different full resolution view of the same 3D image on the same display at the same time.

### CROSS REFERENCE TO RELATED APPLICATION

This application is a Conversion of a Provisional Application titled “High Resolution Multiple Image Stream and Three Dimensional Display” filed with the USPTO on May 28, 2003. The Application Serial Number of the referenced Provisional Application is not known at this time.

### BACKGROUND FIELD OF INVENTION

Modern video monitors incorporate many technologies and methods for providing high quality video to users. Nearly every household in the United States has one or more video monitors in the form of a television or a computer monitor. These devices generally use technologies such as Cathode Ray Tubes (CRT) tubes, Liquid Crystal Displays (LCD), OLEDs, Plasma, Lasers, or Digital Micromirror Devices (DMD) projection in one way or another. Large monitors offer the advantage of enabling many users to see the video monitor simultaneously as in a living room television for example. Often video users do not want to view the same image streams as one another. Instead viewers would often like to see completely different programs or image streams at the same time. Alternately viewers would like to see the same program in 3D (three-dimensional) format.

The prior art describes some attempts to enable multiple viewers to see different image streams concurrently on the same monitor. These are generally drawn to wearing glasses that use polarization or light shutters to filter out the unwanted video stream while enabling the desired video stream to pass to the users' eyes. No prior art provides a technique to enable multiple viewers to view separate video streams concurrently with the unaided eye. Moreover, no display enables true 3D images or alternately multiple program images to be viewed from the same Television pixels at the same time by multiple viewers.

The present invention provides a significant step forward for video monitors. The present invention describes multiple embodiments which enable multiple high resolution video streams to be displayed on the same video monitor concurrently. Each embodiment describes the concurrent presentation and separation of video streams while using the same number of pixels as a typical display. In a preferred embodiment, beam steering optics cause the pixel to be time sequenced and swept across or moved to a range of positions across the user space thus dividing the user space into time sequenced positional segments where each segment receives different light from the same pixel. Thus the view one sees from the display is dependent upon the physical position he or she is in relative to the display. The result is that multiple users can sit in respective viewing segments wherein people in each of the segments can view different video streams on the same display concurrently. Alternately, viewers will see a true 3D image which is dependant upon their position relative to the display.

### BACKGROUND-DESCRIPTION OF PRIOR INVENTION

Many display screens have been described and practiced in the prior art. Modem video monitors incorporate many technologies and methods for providing high quality video to users. Nearly every household in the United States has one or more video monitors in the form of a television or a computer. These devices generally use technologies such as Cathode Ray Tubes (CRT) tubes, Liquid Crystal Displays (LCD), or Digital Micromirror Devices (DMD) in one way or another. Large monitors offer the advantage of enabling many users to see the video monitor simultaneously as in a living room for example. Often video users do not want to view the same video streams as one another.

The prior art describes some attempts to enable multiple viewers to see different video streams concurrently on the same monitor. These are generally drawn to wearing glasses that use polarization or light shutters to filter out the unwanted video stream while enabling the desired video stream to pass to the users' eyes. U.S. Pat. No. 6,188,442 Narayanaswami being one such patent wherein the users where special glasses to see their respective video streams. U.S. Pat. No. 2,832,821 DuMont does provide a device that enables two viewers to see multiple polarized images from the same polarizing optic concurrently. DuMont however also requires that the viewers use separate polarizing screens as portable viewing aids similar to the glasses. DuMont further requires the expense of using two monitors concurrently. No prior art provides a technique to enable multiple viewers to view separate video streams on the same monitor concurrently with the unaided eye as does the present invention.

### BRIEF SUMMARY

The invention described herein represents a significant improvement for the users of video monitors. Heretofore a large family size television for example could only carry one video stream on its entire surface at any given time. Anyone not interested in watching the same video stream was required to use a television in another room or in the case of “picture in picture” to view the video stream on a smaller portion of the same monitor. Likewise if a family member wanted to use the computer or video game, they would have to go to a separate computer or gaming station with a monitor. The present invention enables multiple users to use one video monitor concurrently while each views completely different video content concurrently whether television video, computer video, gaming video, or some other form of video.

The present invention also provides true 3D functionality in the same monitor as above.

The present invention uses a process of time sequenced iterative sweeping of pixels across the user space to physically segment the user space into physically segmented viewing spaces. As light from individual pixels is swept across the user space, each segmented viewing space receives a different color from individual pixels. This process is done concurrently for many thousands of pixels such that a multitude of positionally dependent normal resolution images are produced from the same video display. Thus each respective space segment receives a different respective fill resolution image from the display. Viewers in different segments can watch different programs at the same time. Alternately, each viewing space segment receives a perspective correct view of a true 3D image.

Users within respective user spaces each see unique video streams across the entire surface of the video monitor which are not visible to those in other respective user spaces. Using the techniques described, a multitude of video streams can be displayed concurrently on one video monitor. Examples of DMD projection, and LCD projection embodiments are described but the elements described herein can be used with any type of pixel generating display.

Thus the present invention offers a significant advancement in the functionality of video monitors or displays without diminishing resolution.

### Objects and Advantages

Accordingly, several objects and advantages of my invention are apparent. It is an object of the present invention to provide a monitor which enables multiple viewers to experience completely different video streams simultaneously. This enables families to spend more time together while simultaneously independently experiencing different visual media or while working on different projects in the presence of one another or alternately to concurrently experience true 3D enhanced media. Also, electrical energy can be saved by concentrating visible light energy from a display into narrower user space when just one person is using a monitor. Likewise when multiple users use the same monitor instead of going into a different room, less electric lighting is required. Also, by enabling one monitor to operate as multiple monitors, living space can be conserved which would otherwise be cluttered with a multitude of monitors.

It is an advantage that the present invention doesn't require special eyewear, eyeglasses, goggles, or portable viewing devices as does the prior art.

It is an advantage of the present invention that the same monitor that presents multiple positionally segmented image streams also can provide true positionally segmented 3D images.

It is an advantage of the present invention that resolution is not sacrificed in order to achieve 3D images and neither is resolution sacrificed to present multiple concurrent positionally segmented image streams.

Further objects and advantages will become apparent from the enclosed figures and specifications.

### DRAWING FIGURES

FIG. 1 illustrates a pixel compression type single pixel which utilizes time sequenced addressing to horizontally segment users' space into multiple positionally dependent image streams.

FIG. 2 illustrates a pixel mask plate type single pixel which utilizes time sequenced addressing to horizontally segment users' space into multiple positionally dependent image streams.

FIG. 3 illustrates a pixel liquid crystal mask type single pixel which utilizes time sequenced addressing to horizontally segment users' space into multiple positionally dependent image streams.

FIG. 4 illustrates a rotating prism array pixel sweeping type single pixel which utilizes time sequenced addressing to horizontally segment users' space into multiple positionally dependent image streams.

FIG. 5 illustrates a single pixel which utilizes time sequenced addressing to vertically and horizontally segment users' space into multiple positionally dependent image streams, in a first directing state.

FIG. 6 illustrates a single pixel which utilizes time sequenced addressing to vertically and horizontally segment users' space into multiple positionally dependent image streams, in a second directing state.

FIG. 7 illustrates an array of pixels similar to the pixel in FIG. 5 and FIG. 6.

FIG. 8 Illustrates the components of a DMD (digital mirror device) as the pixel source for the elements of FIG. 7.

FIG. 9 Illustrates the components of a LCD (Liquid Crystal Display) as the pixel source for the elements of FIG. 7.

FIG. 10 Illustrates the iterative flow of light from the DMD of FIG. 8 to produce time sequenced positional viewer space segmentation.

FIG. 11 illustrates horizontal user space segmentation achieved with only a time sequenced beam director and without need of intervening optics.

FIG. 12 illustrates vertical and horizontal user space segmentation achieved with a series of two time sequenced beam directors and without need of intervening optics.

FIG. 13 illustrates horizontal user space segmentation achieved with a time sequenced beam director and a space segmenting lenticular without need of intervening optics between the pixel source and the beam director.

### DETAILED DESCRIPTION OF THE INVENTION

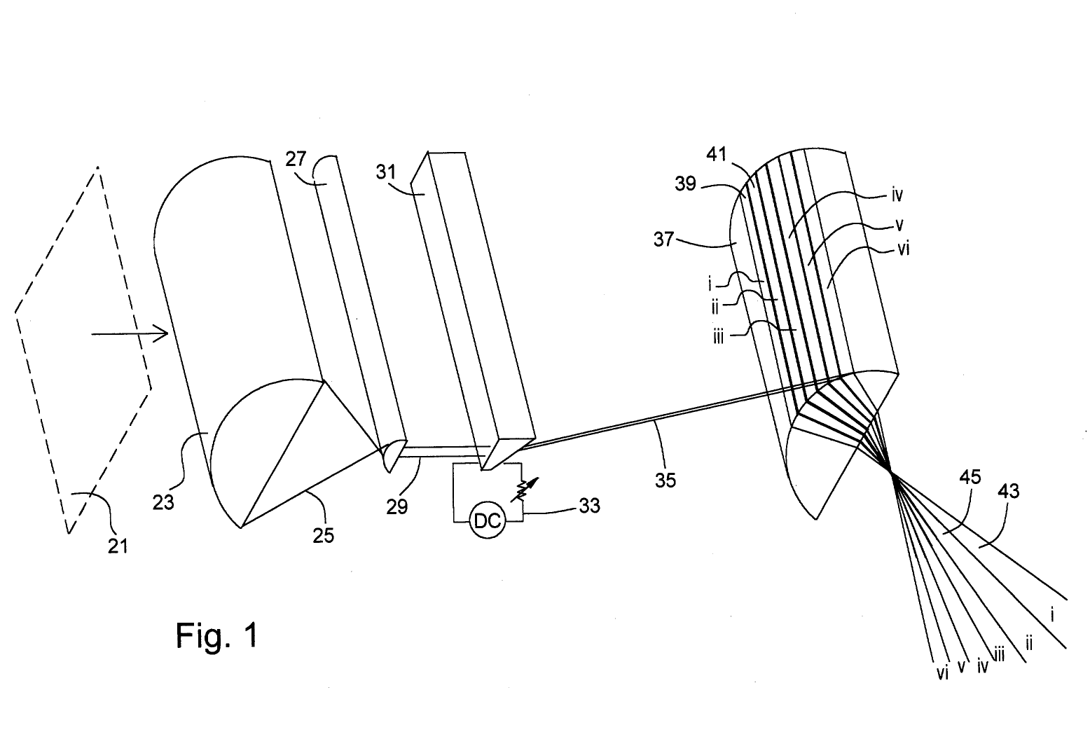

FIG. 1 illustrates a pixel compression type single pixel which utilizes time sequenced addressing to horizontally segment users' space into multiple positionally dependent image streams. A first single pixel 21 from a DMD is incident upon a first compressing lenticular 23. The 21 is produced by a very fast DMD such as a Texas Instruments' DLP and intervening optics that cause the pixel to be collimated, the pixel has time sequenced red, green, and blue phases. The 23 is a lens that is transparent in the visible spectrum. It causes the red, green, and blue sequences to become a first horizontally convergent light 25. The 25 is incident upon a first horizontal collimating lens 27. The 27 is transparent in the visible spectrum and collimates the 25 into first collimated light 29. The 29 is incident upon a first sweeping deflection liquid crystal cell 31. The liquid crystal cell is comprised of liquid crystal material sandwiched between conductor substrates and responsive to varying current levels. Suitable architecture having a sweeping range of up to 45 degrees, has been demonstrated by Kent State University and is described in U.S. Pat. No. 6,188,462 Lavrentovich et al and other controllable deflector architectures are known in the art. Diffraction or refraction may be utilized to cause a range of controllable deflection angles. Current to 31 is controlled by a variable current supply 33. 33 supplies a voltage to 31 such that 29 is deflected into first deflected beam 35. 35 is incident upon a first pixel directing lenticular 37 in the column labeled vi. 37 is a lenticular optic or Fresnel optic which is transparent in the visible spectrum. Due to its incidence on 37 at vi, the light is directed by 37 to a specific section of user space also labeled vi. The 35 is directed by 37. Succeeding pixels from the DMD representative of either entirely different image content or of the same content from a different 3D viewing angle are directed by 31 as controlled by 33 to be incident across a range of positions on 37 including positions, v,iv, iii,ii, and i. Each of these succeeding pixels, containing red, green and blue phases, are respectively viewable in separate respective viewing zones including v,iv, iii,ii, and i. The DMD produces a pixel stream so quickly that the human eye perceives a continuous stream of light coming to each of the respective viewing zones though in actual function, each zone is receiving light representative of its respective image only a fraction of the time. As will be described later, the elements of FIG. 1 represent only one pixel. In practice many thousands of parallel pixels are concurrently being similarly swept across the user space such that users within multiple space segments each receive complete positionally segmented image streams concurrently from the same display device.

Many suppliers of suitable optics for 23, 27, and 37 are well known in the optics and display industries.

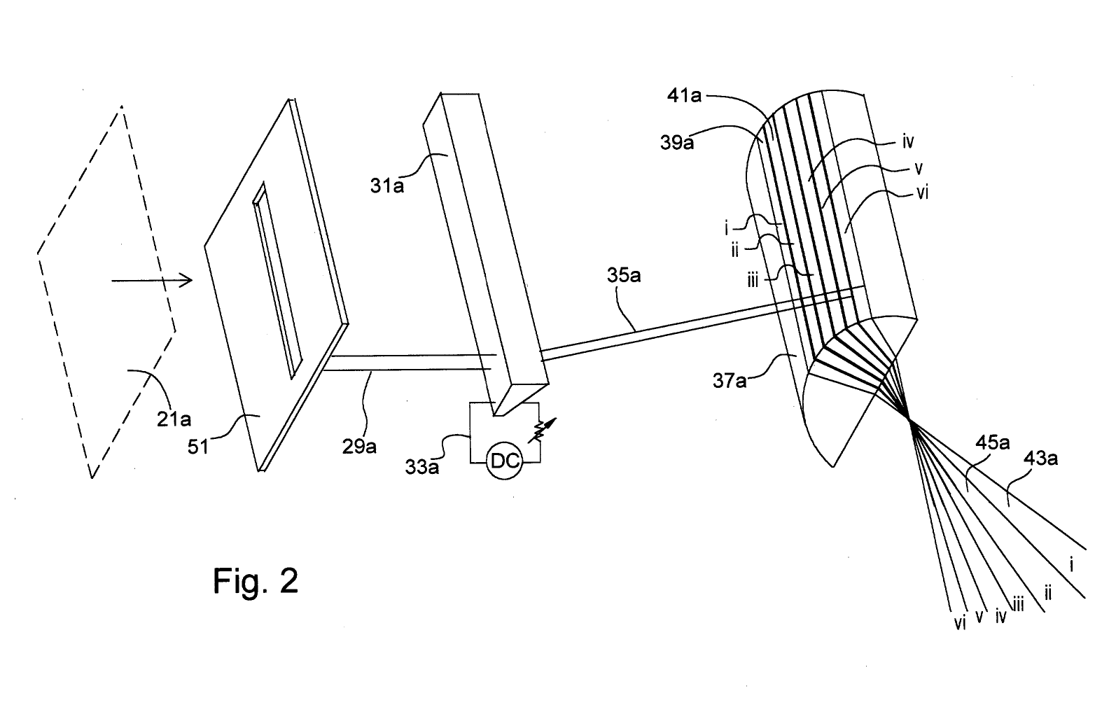

FIG. 2 illustrates a pixel mask plate type single pixel which utilizes time sequenced addressing to horizontally segment users' space into multiple positionally dependent image streams. The elements of FIG. 2 operate identically to those of FIG. 1 except that the 23 and 27 of FIG. 1 have been replaced by the mask plate 51. The 51 creates a narrow slit from the second DMD pixel light 21a which is incident on the 51. Light that is incident on the surface of 51 is absorbed. 51 creates a second horizontally compressed beam 29a. 29a is a second sweeping liquid crystal cell controlled by a second circuit 33a. These elements otherwise operate identically to those in FIG. 1 and produce the same functionality.

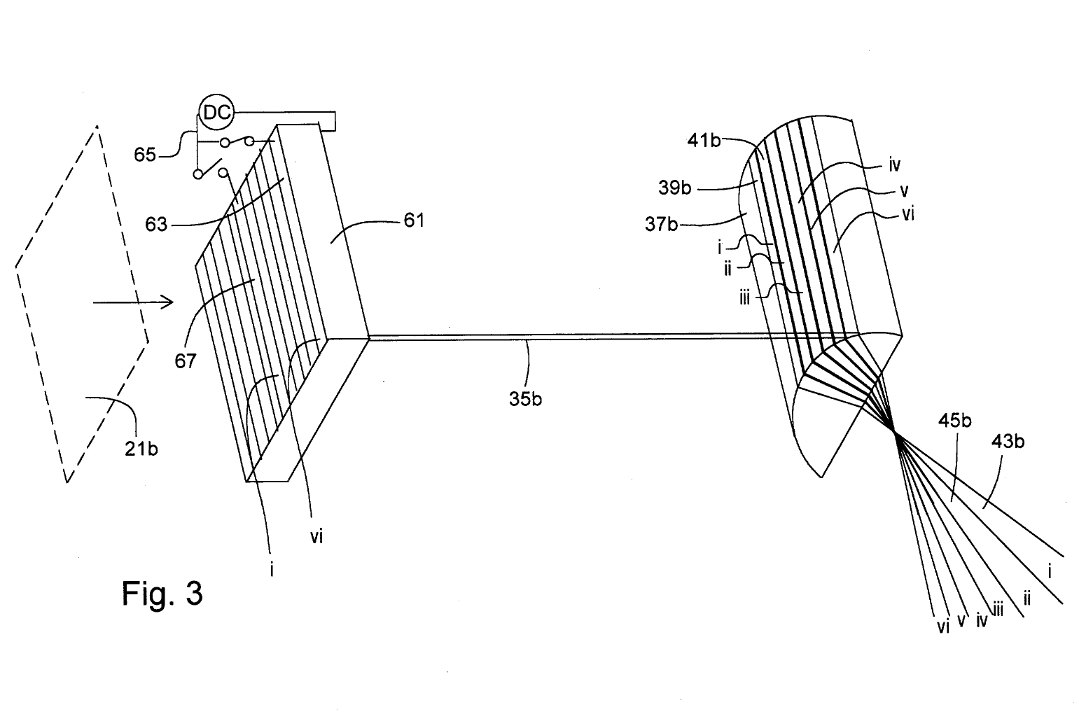

FIG. 3 illustrates a pixel liquid crystal mask type single pixel which utilizes time sequenced addressing to horizontally segment users' space into multiple positionally dependent image streams. A third pixel from DMD 21b is incident upon a segmented liquid crystal filter 16. 61 has a predetermined number of cells each of which are independently controllable by a filter circuit 65. A first light valve 63 is in the open state such that a third narrow column of light 35b is directed to a third horizontal pixel directing lens 37b. Other light valves in 61 are in the closed state including closed valve 67. By opening and closing values in 61 in succession, pixel light can be swept across the 37b and thereby across the user field. As with FIG. 1 and FIG. 2, each of the roman numerals i through vi are representative of a succeeding pixel (including red, green, and blue phases) each of which represents a separate positionally segmented image stream or a different view of the same image stream (when being used as a 3D display).

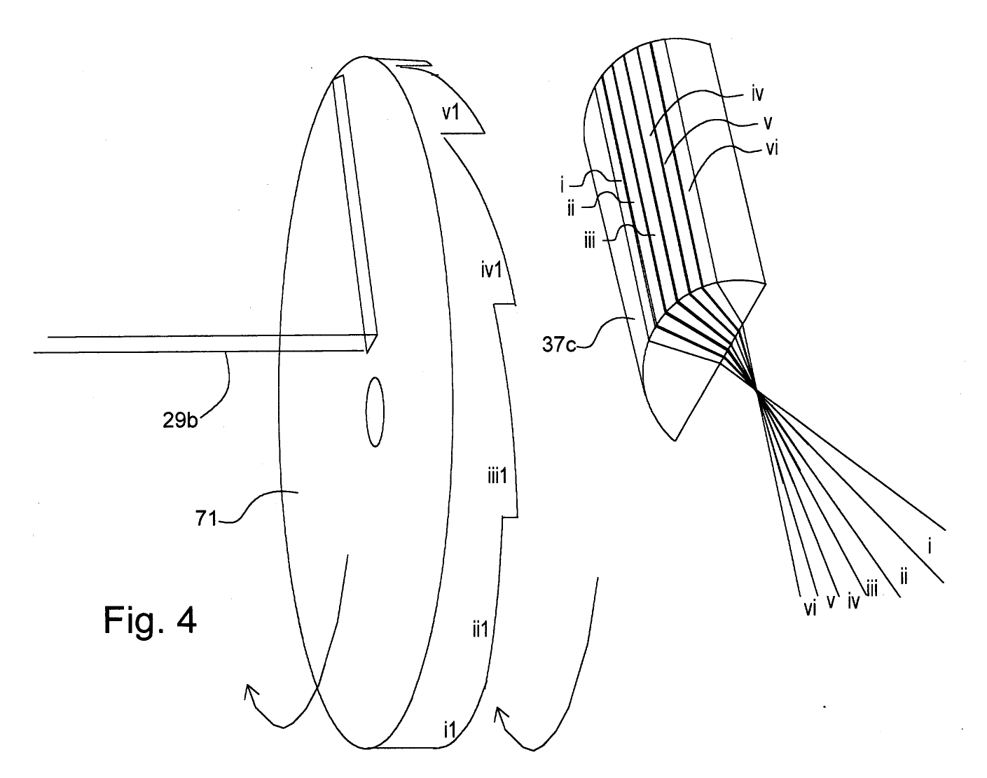

FIG. 4 illustrates a rotating prism array pixel sweeping type single pixel which utilizes time sequenced addressing to horizontally segment users' space into multiple positionally dependent image streams. The elements of FIG. 4 operate similarly to those of FIG. 1 except that 31, and 33 are replaced by a rotating variable deflection optic 71. The 71 has a range of deflecting surfaces that accept the light from 27 as third collimated light 29b and deflect it such that sequential pixels are swept across the third horizontal directing pixel lens 37c. Variable deflection positions on the 71 include i1, ii1, iii1, iv1, and v1. Each of these deflection positions causes light to be incident upon a different respective section of 37c and thereby be directed to a respective section of user space. Thus the elements of FIG. 4 function similarly to FIG. 1. In practice, it is not practicable to have separate mirco rotating structures for each pixel. Alternately, one large rotating variable deflection optic that sweeps all of the display's pixels across their respective pixel directing lenses and thereby across the user space. Another alternate is to slide a rectangular structure back and forth rapidly to variably deflect the 29b (instead of rotating a round structure). The 71 can be a transparent optic with a series of differing prism angles on its surface, or a gradient index prism, or a range of Fresnel zones, or a range of diffraction gratings. Each of these produce the same desired sweeping deflection angles.

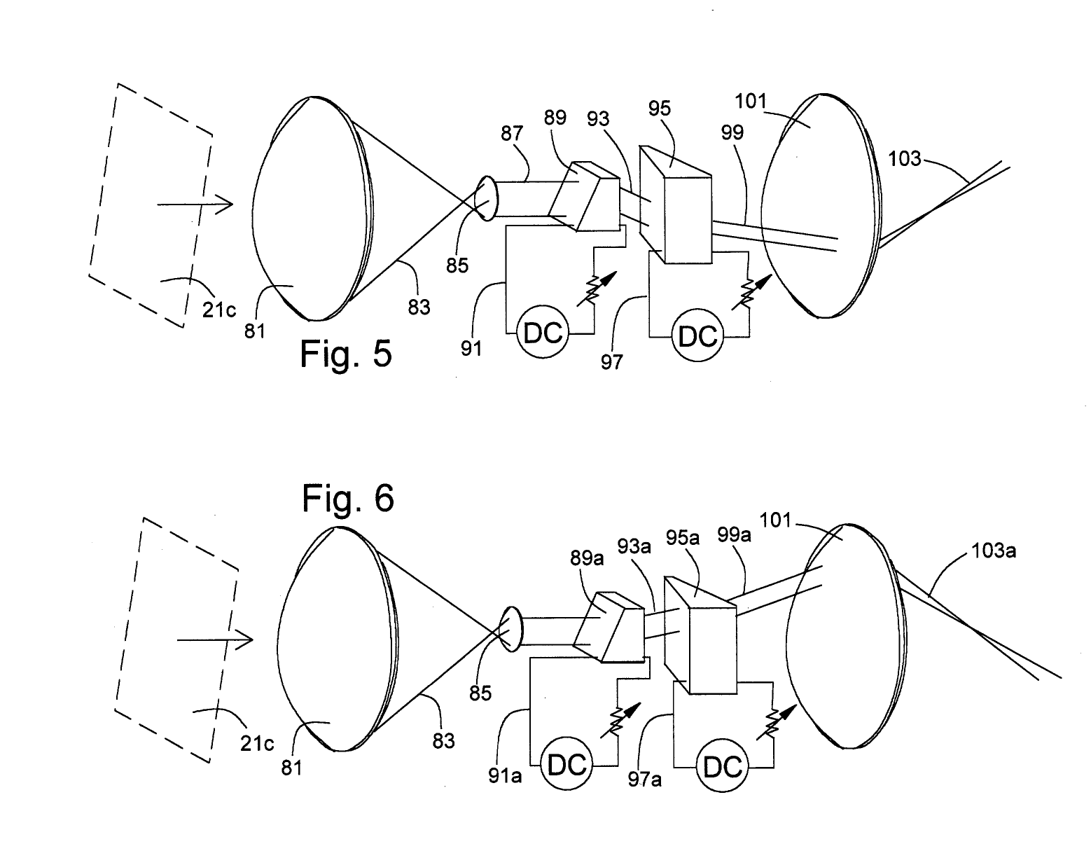

FIG. 5 illustrates a single pixel which utilizes time sequenced addressing to vertically and horizontally segment user space into multiple positionally dependent image streams, in a first directing state. Whereas FIGS. 1 through 4 have been drawn to sweeping a rapid succession of images horizontally across the user space, FIG. 5 illustrates that the same technique can be used to segment the user space both horizontally and vertically. This is particularly useful for providing vertical parallax when viewing true 3D image streams.

A DMD reflects a fourth pixel 21 c which is incident upon a compressing lens 81. The 81 causes the 21c to be compressed into horizontally and vertically compressed pixel 83. The 83 is incident a horizontal and vertical collimating lens 85. 85 causes the 83 to be collimated into fourth collimated light 87 which is then incident upon a vertical deflector 89. The 89 produces a variable deflection angle which is a function of the variable vertical circuit 91 voltage. The 89 deflects 87 to a desired vertical trajectory of light 93 which is then incident upon a third horizontal deflector 95 which is identical to 31 and which is controlled by a third horizontal deflection control circuit 97 voltage which is identical to 33. The 95 imposes a desired horizontal deflection angle on 93 and produces vertically and horizontally swept compressed pixel 99. 99 is incident upon a horizontal and vertical directing optic 101 which causes 99 to be directed to a respective portion of the users space. The user space can thus be segmented into a range of zones which each receive respective pixels representative of different image streams or of different perspectives of the same 3D image.

81, 85, and 101 are converging optics transparent in the visible spectrum and available in suitable sheets from many providers as convex lens arrays on a rigid sheet or Fresnel lens arrays on a rigid sheet.

FIG. 6 illustrates a single pixel which utilizes time sequenced addressing to vertically and horizontally segment users' space into multiple positionally dependent image streams, in a second directing state. All the elements of FIG. 6 are identical to those of FIG. 5 except that the vertical deflector in a second state 89a is caused to create a different vertical trajectory 93a due to a different current on circuit 91a and that horizontal deflector in a second state 95a is caused to create a different horizontal trajectory 99a due to a different current on horizontal circuit 97a. Thus a beam in a different vertical and horizontal plane 99a results. The 99a is incident upon 101 at a different position than was 99 and it is thus directed to a different portion of user space 103a. This diagram illustrates how the components direct light to succeeding portions of user space such that each portion receives a different image stream.

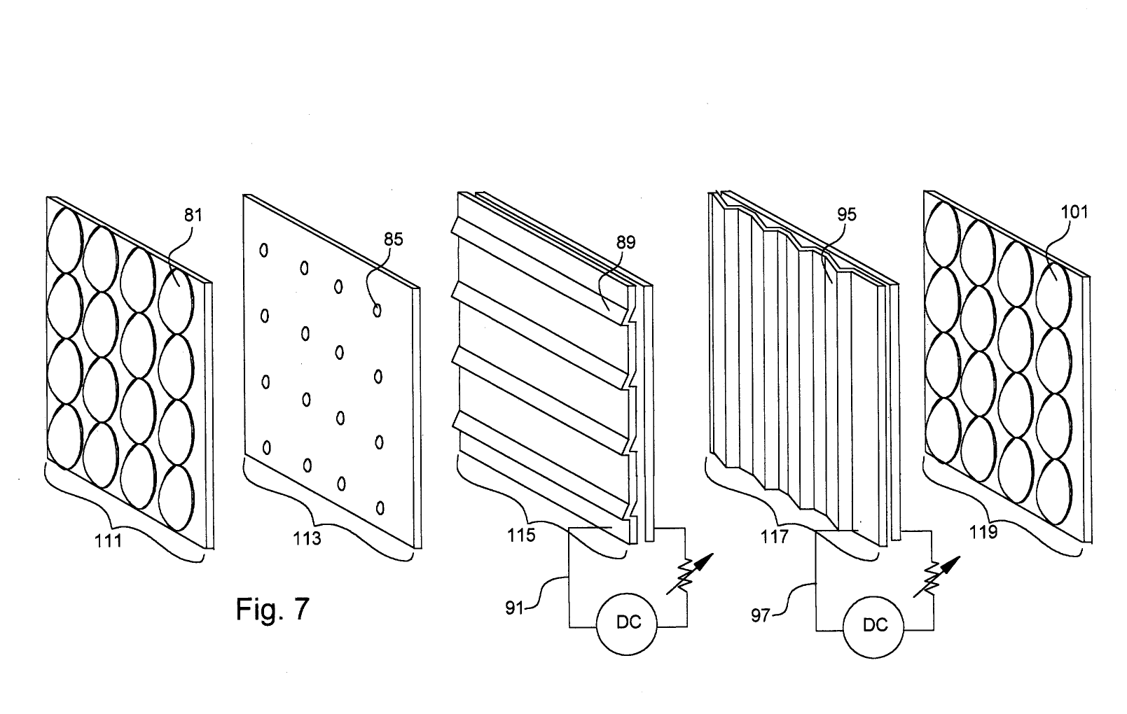

FIG. 7 illustrates an array of pixels similar to that described in FIG. 5 and FIG. 6. In practice, the individual pixel elements of FIGS. 1 through 6 are arranged in sheets of many thousands which are parallely operated concurrently to provide positionally dependent coherent images to a multitude of user positions.

The element of FIG. 7 include those of FIGS. 5 and 6 including 81, 85, 89, 95, and 101. A sheet of compressing optics in array 111 receives multiple pixel light from the DMD (and interviewing optics). At the pixel level, each of the pixels is compressed by 111 and directed to a sheet of collimating optics in array 113. The 113 collimates each of the individual pixels and directs them to a vertical beam deflector array 115 which is controlled by 91. The 115 creates the desired vertical trajectory, and passes the light to a horizontal beam deflector array 117 which directs the light horizontally. Light from 117 is incident on desired successive areas of a directing pixel array 119. Depending upon where the light from 117 is incident upon each pixel in 119 successive images will be directed to positionally segmented portions of the user space.

It should be noted that light throughput may be enhanced by putting intervening polarizing elements between the elements of FIG. 7 (or of any of the Figures in this patent application). This is so because in the current state of the art, liquid crystal deflectors only allow one plane of polarization to pass. Conditioning the light to pass in the requisite plane when necessary is therefore desirable. Also when the light is being deflected vertically by 115, then horizontally by 117, an intervening layer that twists the light polarization from 115 to be in an optimum plane for 117 may be required depending upon the characteristics of the materials used for 115 and 117. (If the 115 and the 117 are polarized in opposite planes, no throughput will be achieved without an interviewing optic to twist the light's polarization plane.) Materials that twist the polarization plane of light are known and available to those skilled in the arts of liquid crystals and displays.

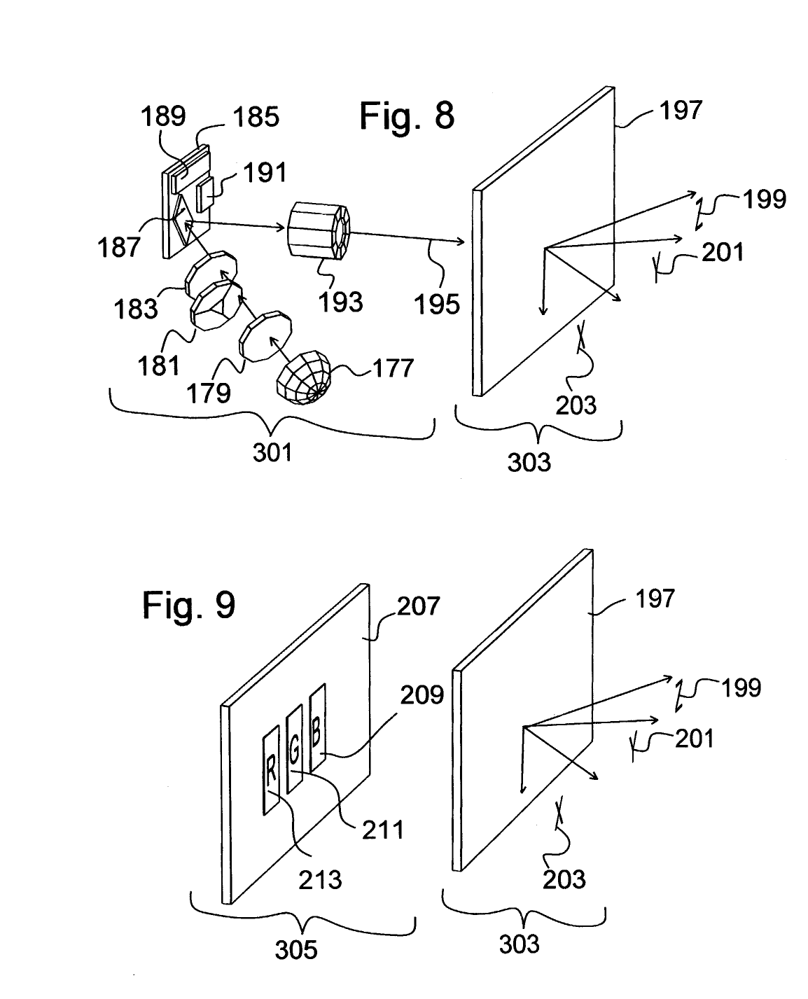

FIG. 8 Illustrates the components of a DMD (Digital Micromirror Device) as the driver for the elements of FIG. 7. The elements of a DMD 301 include a light source 177, a first DMD optic, a rotating light color filter wheel 181, a second DMD optic 183, digital mirrors on a chip 187, a board 185, a processor 189, a focusing optic 193 and a resultant pixel plurality emission stream 195. The DMD light is directed to the assembled time sequenced sweeping elements 303 which is an assembly of all of the elements FIG. 7. In operation, the 303 directs the light sent by the 301 into positionally segmented image streams. Three such streams are shown. Concurrently, users in a first space 203 see “X”, users in a second space 201 see “Y”, and users in a third space 199 see “Z”. X, Y, and Z, can be three separate television programs or they can be three different views of a single 3D image. Using the architecture described and the known speed of a Texas Instruments DLP, tens of positionally segmented concurrent images can be displayed simultaneously at the same resolution that the DLP produces.

Note that if 195 is collimated prior to incidence upon 303, lenses in 199 can be identical to one another. If 195 is not collimated prior to incidence upon 303, lenses in 199 should be individually structured to direct the light in parallel planes which are parallel to the optical axis of the display's head on view in addition to compressing the light as discussed above.

FIG. 9 Illustrates the components of a LCD (Liquid Crystal Display) as the driver for the elements of FIG. 7. The elements of an LCD image projection system 305 produce collimated light which is incident upon 303. An LCD can thus provide the light color control for the display of the present invention.

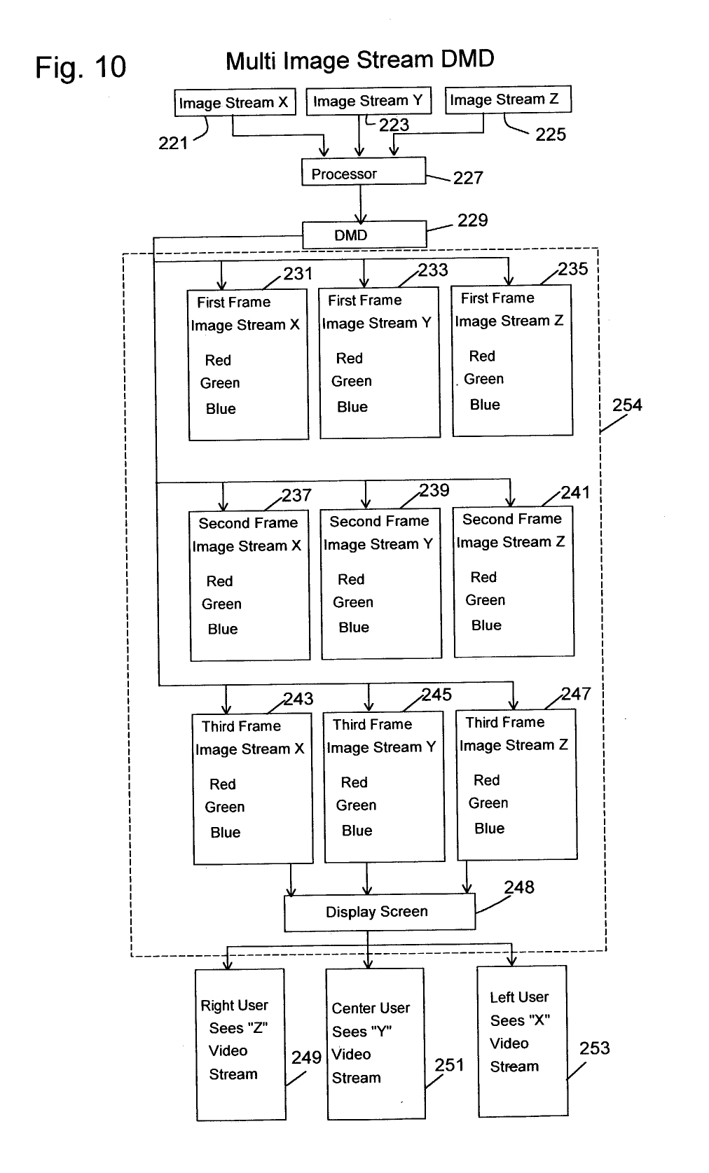

FIG. 10 Illustrates the flow of light from the DMD of FIG. 8. In practice, the display provides successive complete images to respective portions of user space.

In the separate image stream application where users are watching different programs concurrently. First the DMD mirrors pass through a first three position red, green, and blue set corresponding to first frame of first image stream X 231. Meanwhile the elements of 303 send these first red green and blue pixel to user space 203 in FIG. 9.

Second the DMD mirrors pass through a second three position set corresponding to second image 233. These three positions depict red, then green, then blue of a first image frame of the second image stream. Meanwhile the elements of 303 send these second red green and blue pixels to user space 201 in FIG. 9.

Third, the DMD mirrors pass through a third three position sets corresponding to third image 235. These three positions depict red, then green, then blue of a first image frame of the third image stream. Meanwhile the elements of 303 send these third red green and blue pixels to user space 199 in FIG. 9.

Thus, each user space has received the first image of three respective image streams. This system is repeated iteratively such that each user space receives a coherent image stream.

The processor integrates multiple image streams together to control the DMD such that it produces a series of images for different streams.

In the 3D application, different views of the same image are substituted for the different image streams.

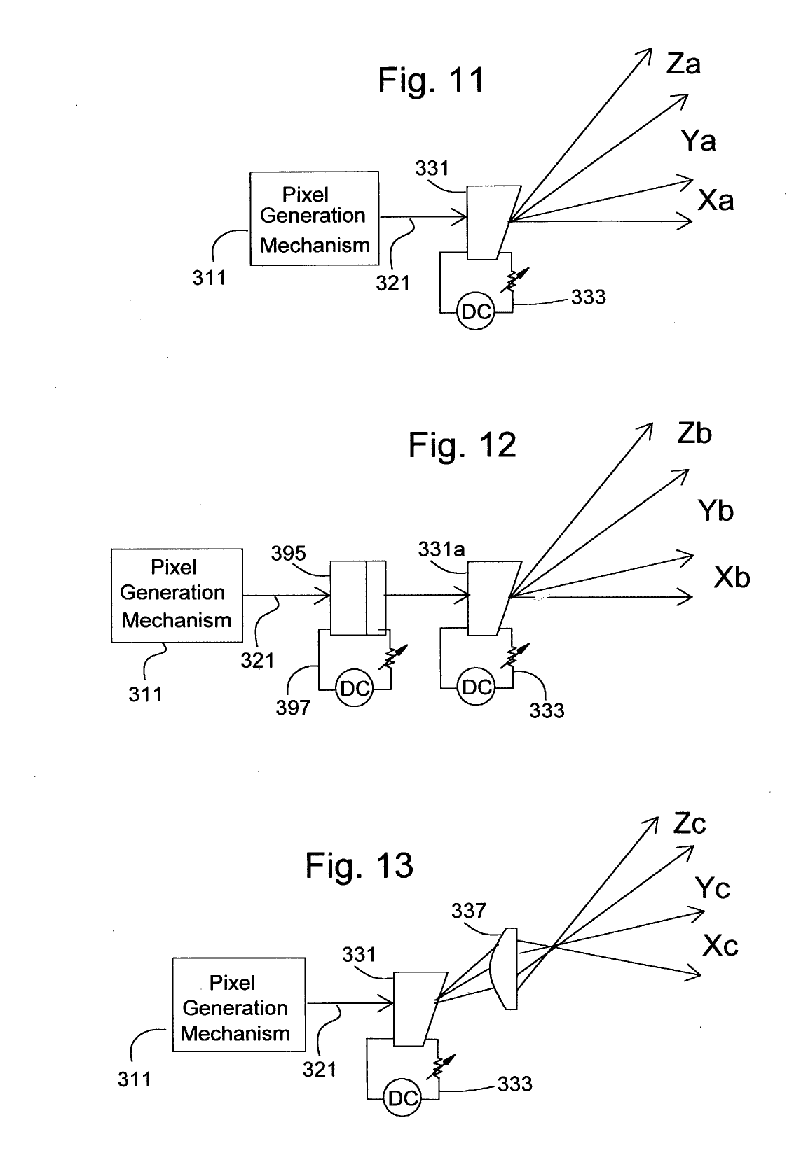

FIG. 11 illustrates horizontal user space segmentation achieved with only a time sequenced beam director and without need of intervening optics. A pixel generation mechanism 311 such as the previously discussed DMD or LCD produces a stream of pixels representative of multiple concurrent programs (image streams) or of different views of a 3D image. Individual pixel light 321 is emitted from the 311. The 321 being one of thousands of parallely generated pixels generated by the 311. DMDs and LCDs are well suited to produce collimated, convergent, or divergent light either with or without additional intervening optics using well known principals and techniques such that 321 can be convergent, divergent or collimated. 321 is incident upon a horizontal space segmenting beam deflector 331 similar to those using refraction or diffraction discussed above. 331 produces a range of deflection angles in rapid succession in response to deflector circuit 333. The result is that 321 light is directed to user space physical segments Xa, Ya, and Za in rapid succession. With each respective physical segment receiving light representative of a different program (or image) stream or of a different view of the same 3D object. The 331 is operated in a rapid iterative process as was described under FIG. 10.

FIG. 12 illustrates vertical and horizontal user space segmentation achieved with a series of two time sequenced beam directors and without need of intervening optics. FIG. 12 comprises the same elements as FIG. 11 except that a vertically segmenting deflector 395 has been added to enable vertical user space segmentation when iteratively caused to rapidly deflect the pixel's light through a range of angles in response to current provided by a vertical deflector circuit 397. Thus vertically and horizontally user space segments including Xb, Yb, and Zb are produced. Users in each of these segments perceives a different television program or a different view of the same 3D program.

FIG. 13 illustrates horizontal user space segmentation achieved with a time sequenced beam director and a space segmenting lens without need of intervening optics between the pixel source and the beam director. FIG. 13 is identical to FIG. 11 except that a pixel directing lens 337 has been added. The 337 enables the pixel light to efficiently direct light to segments of the user space including Xc, Yc, and Zc.

### Operation of the Invention

Operation of the invention has been discussed under the above heading and is not repeated here to avoid redundancy.

### Conclusion, Ramifications, and Scope

Thus the reader will see that the Time Sequenced User Space Segmentation For Multiple Program and 3D Display of this invention provides a novel unanticipated, highly functional and reliable means for distributing multiple video streams to segmented user spaces such that users within each respective space can view distinct video streams or true 3D views of the same video stream.

While my above description describes many specifications, these should not be construed as limitations on the scope of the invention, but rather as an exemplification of a preferred embodiment thereof Many other variations are possible. Many types of video monitors are well known and can be used with the method and elements described herein. For example, many techniques for projecting images are well known and could be used by one skilled in the art to physically segment multiple video streams according to the present invention. Many optical elements and combinations thereof are possible. Many optical arrangements of intervening optics have been described herein and others are possible using that which is taught herein. It should be understood that the term “display” refers to a video monitor, television screen, a computer screen, a video game screen, or device which substantially provides images to a user.

What is claimed:

1. An image display system for providing a first image to a first portion of user space and a second image to a second portion of user space wherein a user in the first portion of space can see the first image but can not see the second image and wherein time sequencing is used to direct images to each respective user space.
